(19) United States
(12) Patent Application Publication
(10) Pub. No.: US 2015/0247565 A1
(43) Pub. Date: Sep. 3, 2015

(54) Transmission Bearing Lube Transfer Hub

(71) Applicant: PACIFIC TORQUE, LLC., Seattle, WA (US)

(72) Inventors: James A. Irish, Seattle, WA (US); Jason L. Bartnes, Seattle, WA (US)

(21) Appl. No.: 14/195,439

(22) Filed: Mar. 3, 2014

(51) Int. Cl. F16H 57/04; B23P 15/00

(52) U.S. Cl. CPC F16H 57/0427; B23P 15/003

(57) ABSTRACT

Disclosed herein are several examples of a transmission lube transfer hub and a method for modifying a transmission to overcome premature failure problems. The modification in one example includes significant modification to a lube transfer hub and replacement of a bearing assembly with a bearing assembly having a larger outer diameter. Modification may also include modification to the transmission casing by plugging of one or more clutch feed passages and drilling of cutoff passages past the plug. Modification may also be made to a ring gear hub and/or clutch hub to allow for a bearing assembly having a larger width.

### BRIEF SUMMARY OF THE DISCLOSURE

Disclosed herein are several examples of a transmission lube transfer hub comprising a longitudinally forward face having a plurality of surfaces defining fastener voids there through and a surface defining a shaft bore there through. The oil transfer hub may also comprise a radially outermost convex surface; a cylindrical radially outward convex casing bulkhead engagement surface; a cylindrical radially inward hub engagement surface; a surface defining an circumferential oil channel radially inward of and formed in the casing bulkhead engagement surface; a plurality of oil passages extending from the oil channel to the hub engagement surface; a planar and cylindrical bearing engagement surface. In one example, the lube transfer hub does not extend longitudinally forward of the forward surface of the bearing engagement surface.

The transmission lube transfer hub as recited above may further comprise a circumferential angled chamfer surface extending from the bearing engagement surface to the hub engagement surface.

Also disclosed is a method for modifying a transmission having a casing including a casing bulkhead with a bore therein. The method comprising the steps of identifying and removing a first oil transfer hub and an associated first bearing assembly from the casing bulkhead and installing a modified oil transfer hub. The modified oil transfer hub in one example comprising: a longitudinally forward face having a plurality of surfaces defining fastener voids there through and a surface defining a shaft bore there through; a radially outermost convex surface; a cylindrical radially outward convex casing bulkhead engagement surface; a cylindrical radially inward hub engagement surface; a surface defining an circumferential oil channel radially inward of and formed in the casing bulkhead engagement surface; a plurality of oil passages extending from the oil channel to the hub engagement surface; a planar and cylindrical bearing engagement surface. In one example, the lube transfer hub does not extend longitudinally rearward of the forward surface of the bearing engagement surface.

The method in one example further comprising the step of replacing the first bearing assembly with a second bearing assembly into the casing bulkhead with a friction fit to the casing bulkhead; and wherein the second bearing assembly has a substantially larger outer diameter than the first bearing assembly and an inner diameter the same as the inner diameter as the first bearing assembly.

The method for modifying a transmission as recited above may further comprise the step of machining a hub of an adjacent ring gear hub to reduce the longitudinally forward edge of the ring gear hub.

The method for modifying a transmission as recited above may further comprise the step of machining a hub of an adjacent high range to reduce the longitudinally forward edge of the ring gear hub.

The method for modifying a transmission as recited above may further comprise the steps of: identifying and plugging a clutch feed passage with a plug adjacent the first bearing assembly; and drilling at least one cutoff passage from the clutch feed passage at a point radially outward of the plug to the circumferential oil channel.

The method for modifying a transmission as recited above may be achieved wherein the total cross sectional area of the cutoff passages is equal to or greater than the cross sectional area of the clutch feed passage.

The method for modifying a transmission as recited above may be achieved wherein the cutoff passages are at an angle to the clutch feed passage in both a radial and a longitudinal direction.

The method for modifying a transmission as recited above may further comprise the steps of: identifying and removing a first bearing keeper from the casing bulkhead; and identifying and machining a substantial portion of a surface defining a central bore hole in the bearing keeper to account for the larger outer diameter of the second bearing assembly.

The method for modifying a transmission as recited above may further comprise the steps of: identifying and removing a first bearing keeper from the casing bulkhead; and replacing the first bearing keeper with a second bearing keeper having a surface defining a central bore hole substantially larger in diameter than the diameter of the surface defining the central bore hole in the first bearing keeper.

### BRIEF DESCRIPTION OF THE SEVERAL VIEWS OF THE DRAWINGS

FIG. 1 is a cross-sectional side view of one example of a prior art off-highway transmission.

FIG. 2 is an enlarged view of the region 2 of FIG. 1.

FIG. 3 is an enlarged view of the region 3 of FIG. 2.

FIG. 4 is an enlarged view of the region 4 of FIG. 3

FIG. 5 is a side isometric view of the off-highway transmission shown in FIG. 1.

FIG. 6 is an exploded view of several components of the off-highway transmission shown in FIG. 1.

FIG. 7 is an exploded view of several components of the off-highway transmission shown in FIG. 1.

FIG. 8 is an exploded view of several components of the off-highway transmission shown in FIG. 1.

FIG. 9 is a front isometric view of one example of an improved lube transfer hub.

FIG. 10 is a cutaway view taken along line 10-10 of FIG. 9.

FIG. 11 is a side view of the improved lube transfer hub shown in FIG. 9.

FIG. 12 is a front face view of the improved lube transfer hub shown in FIG. 9.

FIG. 13 is a back face view of the improved lube transfer hub shown in FIG. 9.

FIG. 14 is a front isometric view of a prior art bearing assembly.

FIG. 15 is a cutaway view of the improved oil transfer hub shown in FIG. 9 combined with a bearing assembly.

FIG. 16 is an illustrative end view of one component of the original casing.

FIG. 17 is a schematic cutaway view of the prior art components shown in FIG. 4.

FIG. 18 is a schematic cutaway view of the assembly shown in FIG. 15 installed in an off-highway transmission.

FIG. 19 is an illustrative end view of one component of the modified casing.

FIG. 20 is an illustrative end view of one component of the modified casing with an oil transfer hub 84 mounted therein.

### DETAILED DESCRIPTION OF THE DISCLOSURE

Disclosed herein are improvements and modifications to an off-highway transmission such as those commonly used in high-pressure pumping apparatus. Such high-pressure pumping apparatus are utilized in parallel or in series and off-highway applications such as for example pressurizing and pumping of fluids or gases for fracturing operations. Such fracturing operations include specific gas and oil mining/pumping applications.

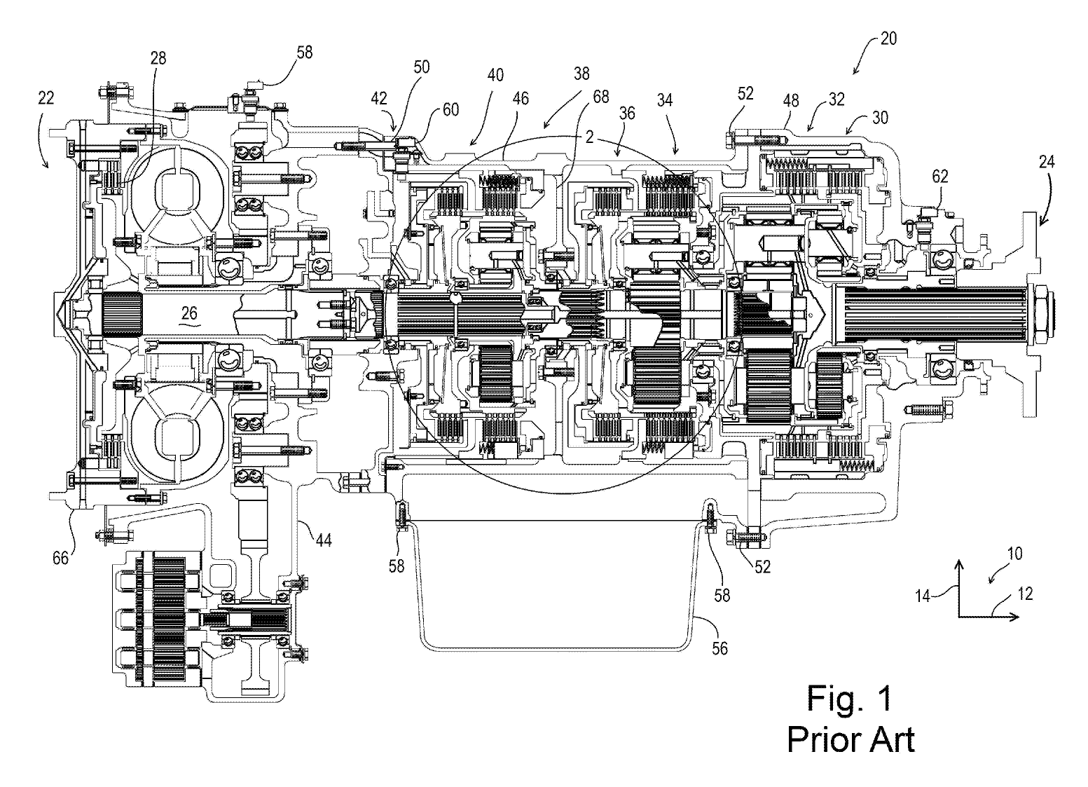

Shown in FIG. 1 is one example of a prior art transmission 20 having at one end an engine input 22 and at the opposing longitudinal end a transmission output 24. For example, the engine input 22 may be attached to a gas, electric, diesel or other engine producing rotational torque to a shaft 26 of the transmission 20. Such transmissions and engines are well-known in the art. To adjust the input rotational speed at the engine input 22 relative to rotational speed and torque at the transmission output 24, a gearing system is utilized within the transmission 20. Commonly, a plurality of clutches such as clutch 28 are utilized to temporarily disconnect the transmission 20 from an engine attached to the engine input 22 and/or a pump or equivalent apparatus attached to the transmission output 24. In the prior art example shown in these figures, the gearing system is adjustable and may in one example include a reverse gear 30, low gear 32, intermediate gear 34, and high gear 36. In addition, a low splitter 38 and high splitter 40 may be included.

In the example shown, substantially all of the moving components are contained within a housing 42 comprising a plurality of interconnected casings 44, 46, and 48. In this example, the casings are coupled by way of casing bolts 50 and 52. Several casing bolts 50 and 52 may be used around the periphery of the casings at each connection location between casings. As can be seen in FIG. 8 for example, it is common to utilize a gasket 54 between each of the casings forming the housing 42 so as to reduce fluid flow or leakage there between. In addition, an oil pan 56 may be attached by way of fasteners 58 to the housing.

In addition, fluid inlet 64 (of FIG. 6) and other fluid inlets not shown may be utilized to introduce (pressurized) fluid for lubrication and/or repositioning of gearing systems and or clutches. Such operation is also well known in the art.

In one form, a flywheel 66 may be provided to ease in operation of the transmission 20. The flywheel 66 may not be enclosed within the housing 44.

Before continuing a description of the apparatus and methods, an axes system 10 (FIG. 6) is disclosed comprising a longitudinal axis 12 generally aligned with the axis of rotation of the shaft 26. A vertical axis 14 is also defined as perpendicular to the longitudinal axis 12; with a transverse axis 16 (FIG. 8) transverse to both of the vertical axis 12 and the longitudinal axis 14. A radial axis 18 is also disclosed as perpendicular to the axis of rotation of the shaft 26.

In continuous operation these off-highway transmissions 20 are often utilized 24 hours a day, seven days a week until the oil or gas withdrawal process is completed. Thus, they are subject to more continuous wear and significantly different operating environments than on-highway transmissions encounter. On-highway transmissions are used between the driving engines and drive train of vehicles such as trucks, buses, trains etc. where it is common to accelerate, and decelerate multiple times during operation; where hills and other obstructions are commonly encountered, and where loads may vary substantially. In off-highway applications, it is more common to bring the engine/transmission/accessory (pump) up to speed and maintain desired speed and pumping pressure for the life of the transmission or until the operation is completed. At which point the apparatus is often moved to the new location and reused. Thus, and applications having a relatively small diameter shaft 26 it was found that breakage of the shaft 26 was common and resulted in downtime significantly reducing the viability of the apparatus.

To overcome the detriment of a relatively small diameter shaft 26, the clear and obvious improvement was to enlarge the size of the shaft 26. As the shaft 26 was modified (enlarged) in diameter, it was clear that many of the internal working components within the housing 42 had to be modified. However, retooling of the housing 42 was found not to be required and therefore, alternate methods for modifying the apparatus to a larger shaft 26 were found by adapting the inner components. The main modification to facilitate the larger (second) shaft 26 is replacing the first bearing assemblies between the shaft and the casing. The replacement (second) bearing assemblies having an increased inner diameter 80, to account for the larger shaft diameter. The outer diameter 82 of the second bearing assembly is substantially the same as the first (original) bearing assembly used with the smaller (original) shaft so as to fit within the original oil transfer hub 84 without modification to the original oil transfer hub 84 nor casing 46.

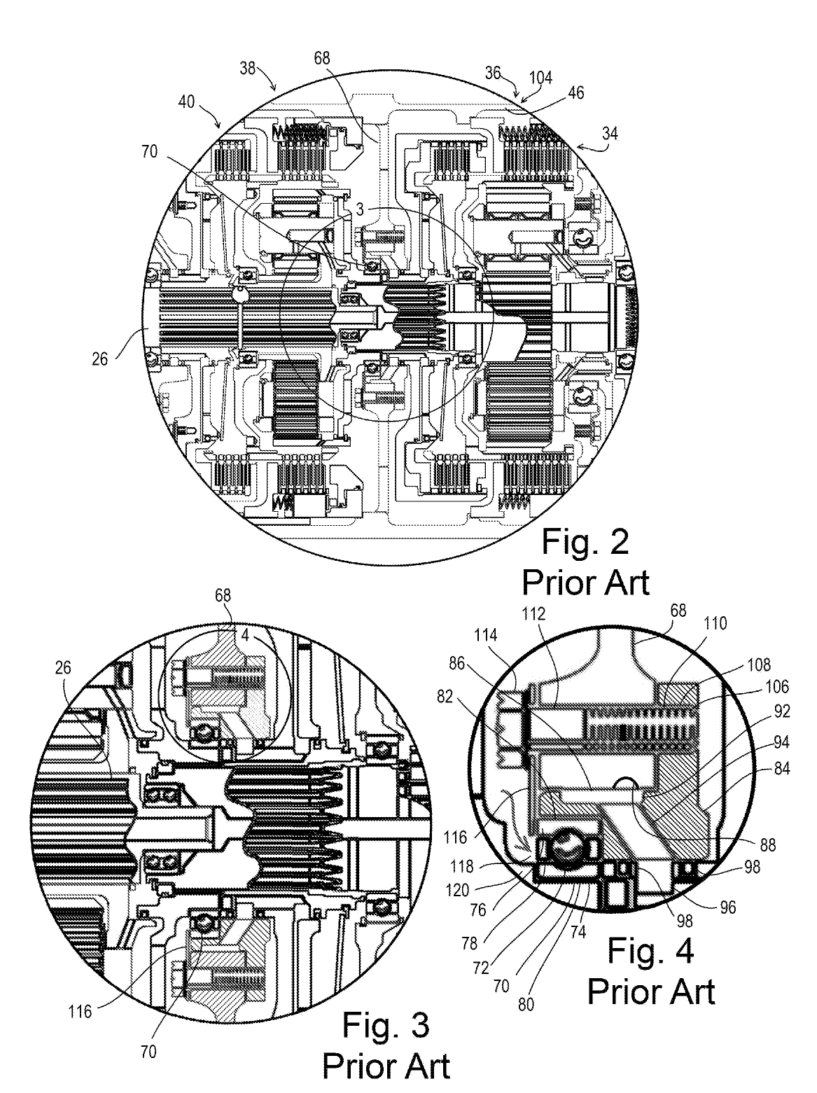

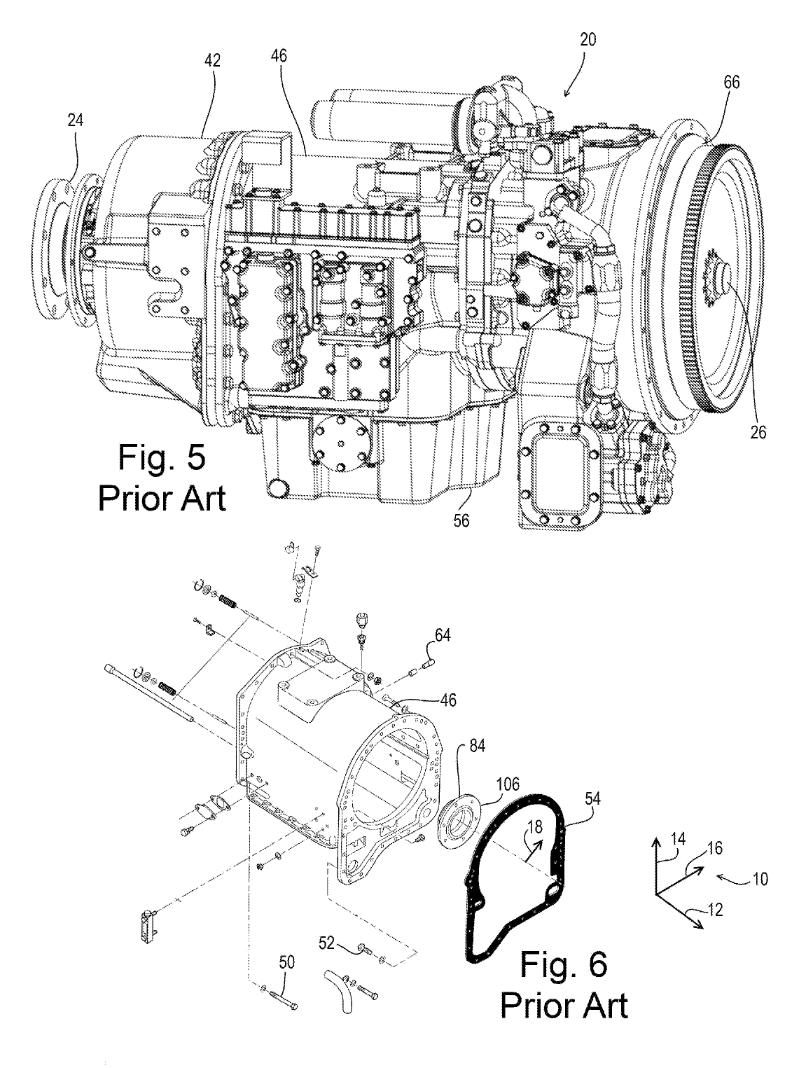

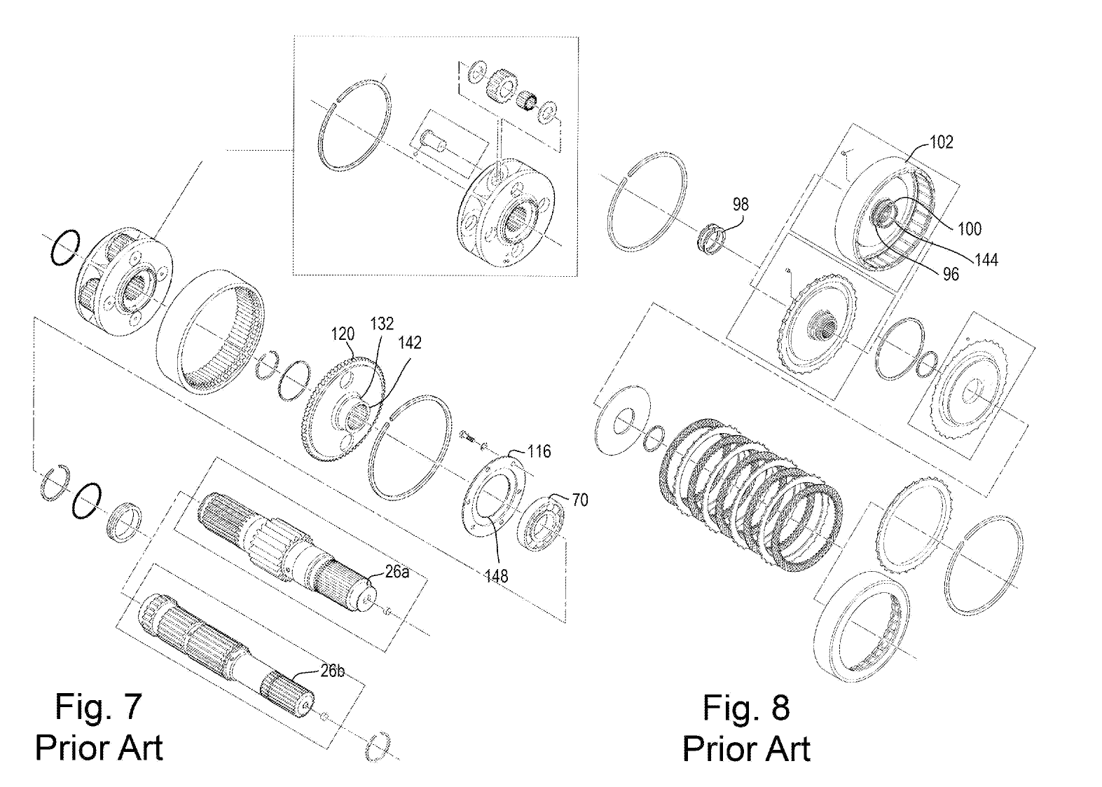

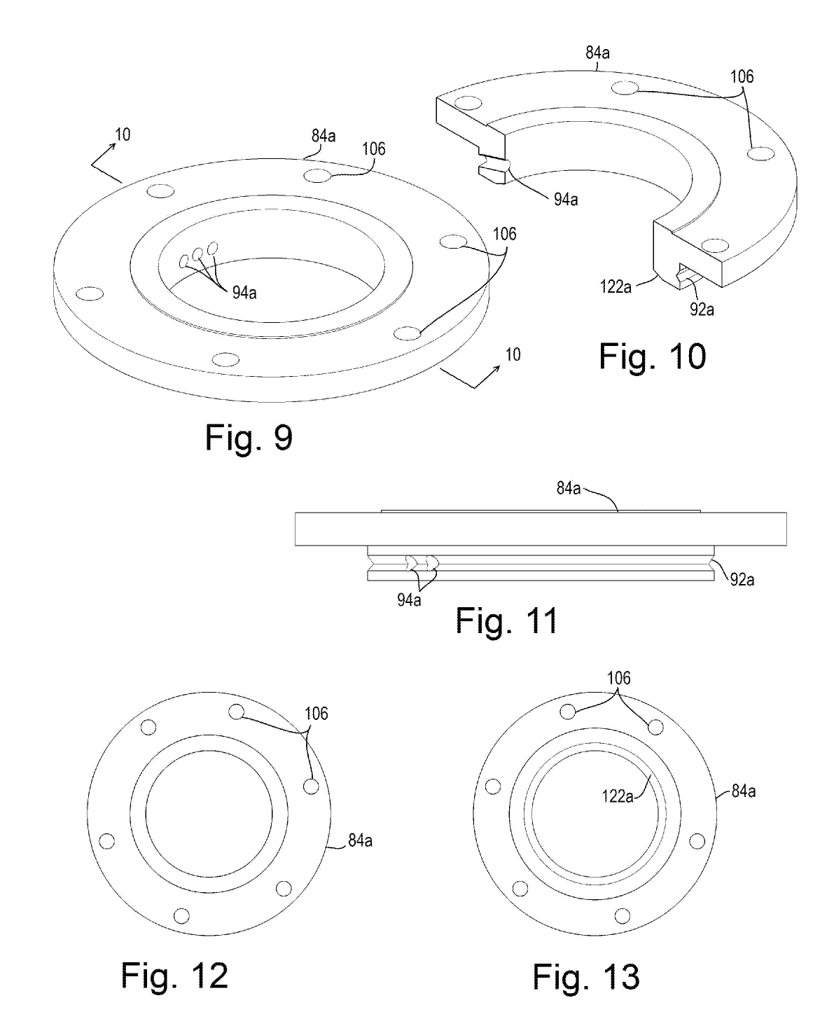

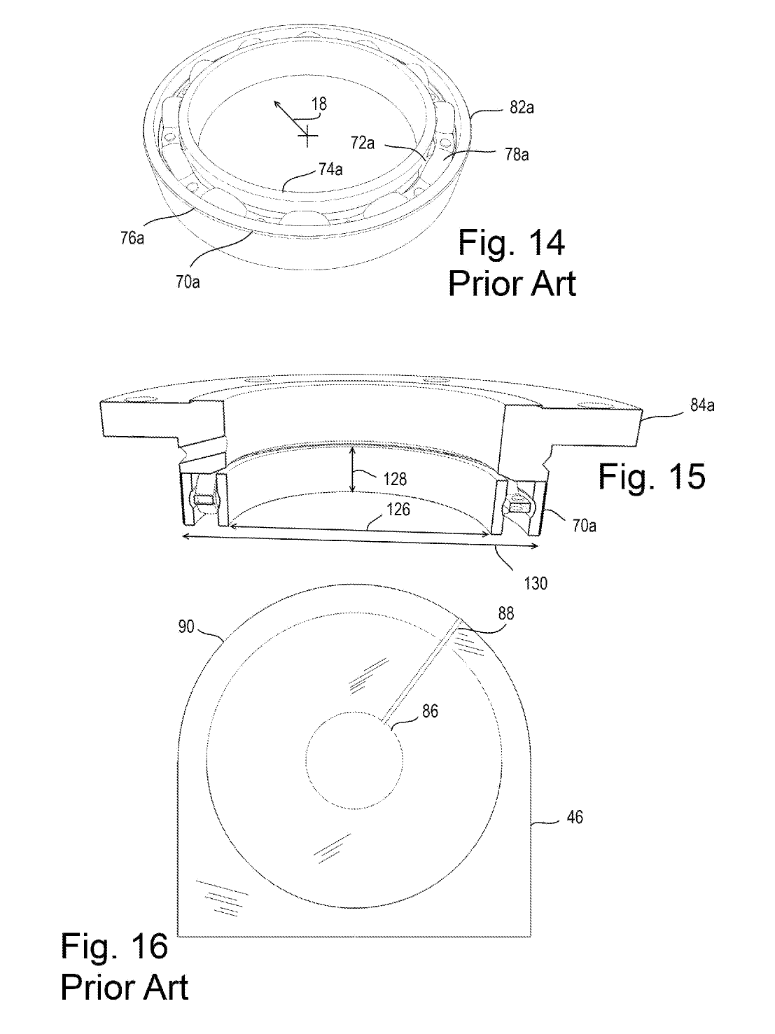

Looking to FIG. 2 (which is a detail view of the center section 2 shown in FIG. 1), it can be seen how the casing 46 comprises a vertical casing bulkhead 68 through which the shaft 26 passes. To reduce friction between the casing bulkhead 68 and the rotating shaft 26, the bearing assembly 70 is positioned therebetween these parts. The relative position of these parts can more clearly be seen in FIG. 4. Such bearing assemblies 70 generally comprising: a plurality of bearings 72, an inner race 74 and an outer race 76. One such bearing assembly 70a is shown in FIG. 14. Bearing assembly 70a differs from bearing assembly 70 in outer diameter 12, but has substantially the same inner diameter 126. The width 128 of the bearing assembly 70a may be somewhat larger than the width of the bearing assembly 70. In many applications, a bearing cage 78 holds each of the bearings 72 in relative position to each other and prohibits them from contacting each other circumferentially which would result in unnecessary wear and tear of all components attached thereto.

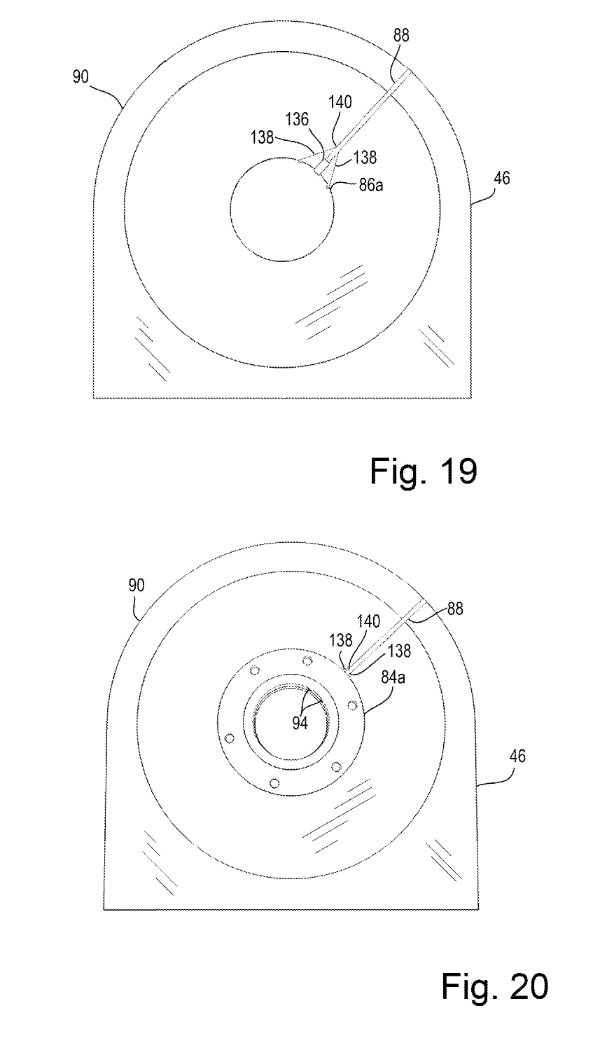

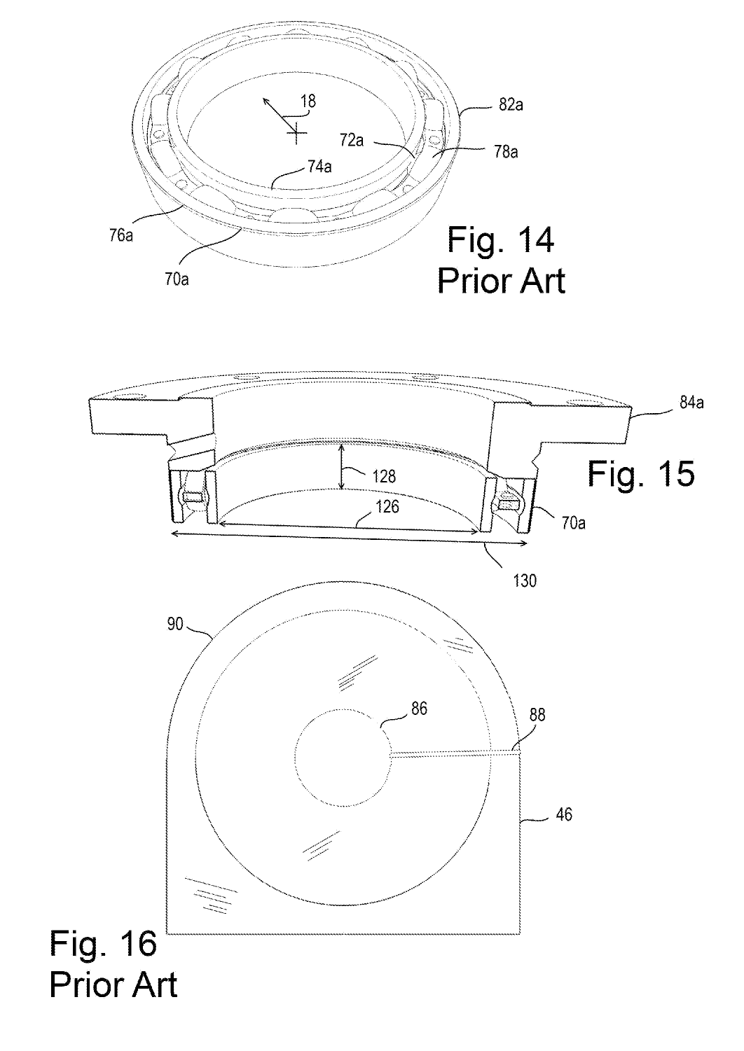

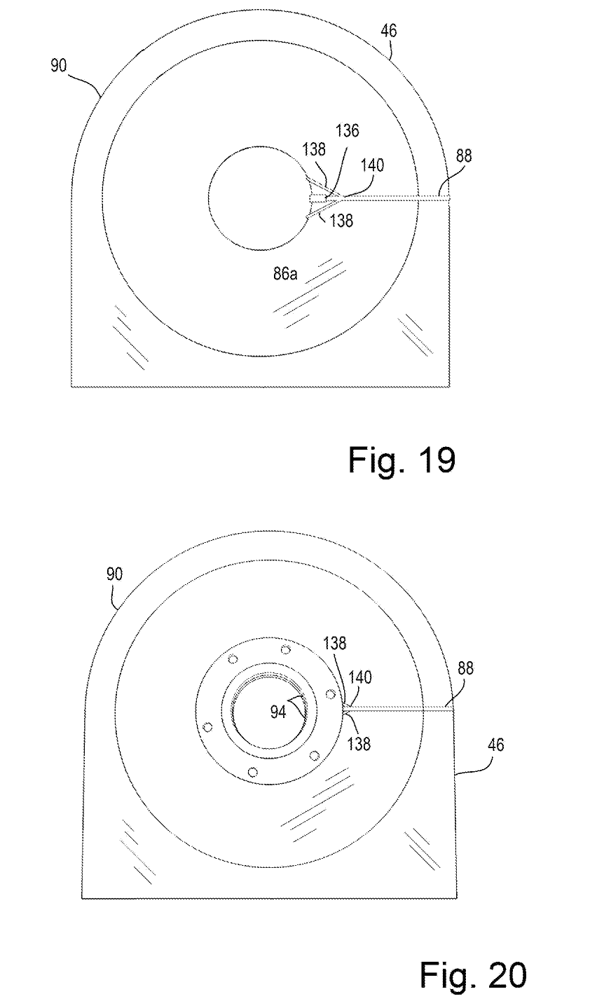

Looking to FIG. 4, it can be seen how an original oil transfer hub 84 is positioned within a cylindrical surface 86 (bore) defining a void of the center support or casing bulkhead 68. This cylindrical surface 86 can also be seen in FIGS. 16 and 19. At the least one clutch feed passage 88 is provided in (through) the casing bulkhead 68 through to the outer surface 90 (FIG. 6) where a conduit or fitting may be provided from a pressure source (pump) such that oil or other fluid may be introduced under pressure to the casing 46, through the clutch feed passages 88, through the surface 86, and to a circumferential oil channel 92 provided in the original oil transfer hub 84.

An angled oil passage 94 extends from the oil channel 92 to a oil channel 96 circumferentially positioned between a plurality of hook seals 98. The hook seals 98 positioned within grooves 100 (FIG. 8). The grooves 100 in this example provided in the hub of a high range drum 102. When pressure is provided through these oil conduits, the high range clutch 104 (FIG. 2) is actuated.

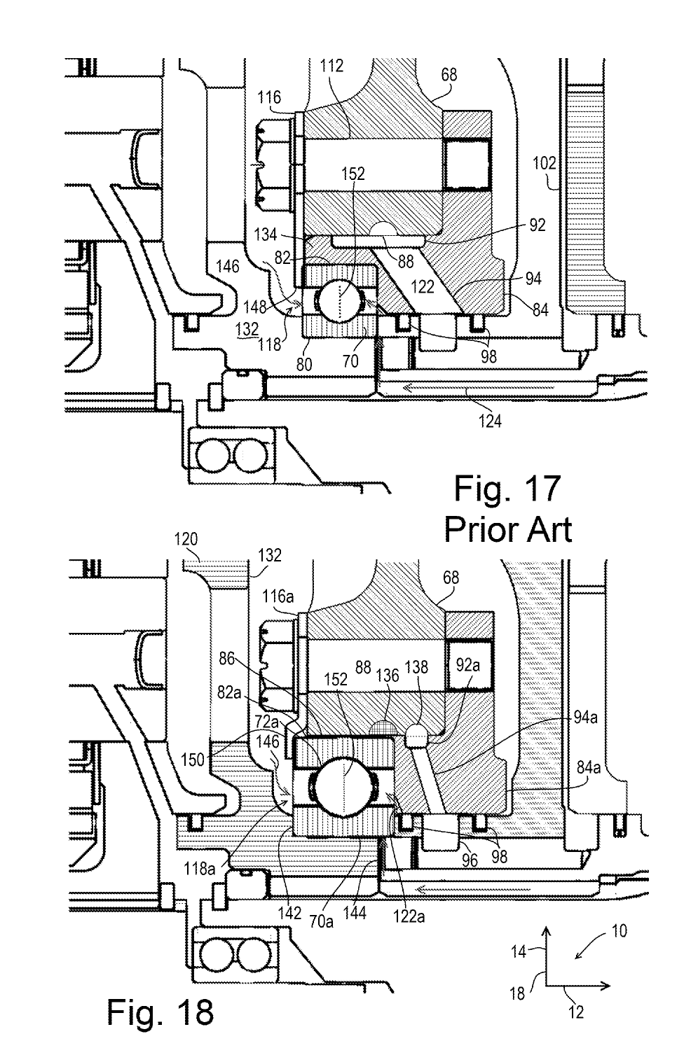

Returning to FIG. 4, the original oil transfer hub 84 also comprises a plurality of threaded voids 106 comprising female threads 108 receiving male threads 110 of a plurality of bolts 112 passing through the casing bulkhead 68 to hold the original oil transfer hub 84 in position during operation. Such bolts 112 generally have a non-cylindrical bolt head 114 for tightening thereof. In the example shown, a bearing retainer 116 overlaps the outer diameter 82 of the bearing assembly 72 hold the bearing assembly 70 in proper position. A circumferential gap is clearly 118 shown between the radially inward side of the bearing retainer 116 and a ring gear 120. This allows for lubrication fluid to “splash” or flow into the bearing assembly 70 to reduce friction therein. FIG. 17 also shows a lubricant flow path 124 past the spline, though a chamfer 122 to the bearing assembly 70.

While replacement of the original (Gen 1) shaft diameter to a larger and stronger (Gen 2) shaft diameter overcame the problem of the shaft breakage, the modification of the original (first) bearing assembly to a second bearing assembly having a smaller overall width required a reduction in the bearing 72 diameter as well as a reduction in the bearing race radial thickness 128. This combination dramatically decreased the operating life of the apparatus in that the smaller bearing assemblies were more prone to failure. Research of the problem indicated that in many installations, frequency vibration from associated components such as the attached engine and or accessory (pump) may have been the cause of dramatic premature failure. To avoid retooling of any components, one proposed solution was to operate the transmission at lower speeds or to avoid installations with specific engine/accessory combinations. For many end-users, this proposed solution has been found to be unacceptable for a variety of reasons.

The present disclosure proposes a new solution involving significant modification of the oil transfer hub 84 allowing for implementation of a bearing assembly 70a having the same inner diameter 126 as the bearing assembly 70 but with a significantly larger outer diameter 130 as well as potentially a significantly larger longitudinal width 128. The proposed solution also includes in some applications; modification to the casing bulkhead 68, modification to the high range drum 102, and/or modification to the hub 132 of the ring gear splitter hub 120. In some applications, modification may also be necessary to the clutch feed passage(s) 88

To ease in cross-reference in this disclosure between an unmodified component and the improved or modified component, an alphanumeric numbering system is used in this disclosure. The alphanumeric numbering system comprising a numeric prefix disclosing a generalized component; and where a modified component is used, an alphabetic suffix is added. For example, the original oil transfer hub 84 shown in FIG. 4 is similar in operation to the modified oil transfer hub 84A shown in FIG. 15. In another example; the bearing assembly 70 shown in FIG. 4 differs in dimension from the bearing assembly 70a shown in FIGS. 14 and 15.

Looking to FIG. 17, it can be seen how a cylinder-like protrusion 134 portion of the oil transfer hub 84 extends longitudinally 12 inward from the longitudinally outward surface of the bearing assembly and engages the radially outward surface 82 of the bearing assembly 70 while the inner surface 80 of the bearing assembly 70 contacts a surface of the ring gear hub 132. It can also be seen how the clutch feed passage 88 intercepts the oil channel 92 at substantially the longitudinal centerline of the casing bulkhead 68 where it exits the casing bulkhead 68. It can also be seen how the oil passages 94 extend from the oil channel 92 as previously discussed. Hook seals 98 can also be seen relative to the high range drum 102 and oil transfer hub 84.

Looking to FIG. 18, it can be seen how installation of the modified bearing 70a may be facilitated with removal of the protrusion 134 discussed above in order to fit within the space allowed and to facilitate implementation of larger bearings 72a. It can also be appreciated how removal of the protrusion 134 and installation of the bearing assembly 70a in one example may block the flow path 124 as the chamfer 122 is removed. Thus, it is proposed in the modified oil transfer hub 84a to provide a modified chamfer 122a.

It can also be appreciated in some examples that the radially outward surface 82a of the modified bearing 70a may block or obscure the clutch feed passage 88. In addition, the oil channel 92a of the modified oil transfer hub 84a is at a different longitudinal position than the oil channels 92. Thus, it is proposed to provide a plug 136 (see also FIG. 19) and to then provide (drill) a cutoff passage 138 or plurality of cutoff passages 138 (See FIG. 19-20) drilled to intersect the clutch feed passage 88 at a point 140 radially outward from the plug 136. This to be noted that in FIGS. 16, 19, and 20, the clutch feed passages 88, plugs 136 and cutoff passages 138 are shown for illustrative purposes and are not definitive in their number, angle, or diameter. Where the cutoff passages 138 are of a smaller diameter than the clutch feed passage 88, it may be desired that a plurality of cutoff passages 138 be provided between the clutch feed passage 88 and the oil channel 92a such that the combined cross-sectional area of the cutoff passages 138 total or substantially total the cross-sectional area of the clutch feed passage 88 so as to eliminate any constriction there between resulting in limited flow of pressure fluid. In some applications, the pressure of the control fluid is sufficient to overcome small constrictions and still allow proper function of the associated clutch or moving apparatus. While two such oil passages 94a are shown, one oil passage may suffice, or three or more passages may be desired for some applications/installations. In addition, the oil channel 92a may be v-shaped in cross section as shown in FIG. 11, u-shaped as shown in FIG. 18, or other shapes.

As the longitudinal position of the oil channel 92 cut off passages 138 at the point which they cross the surface 86 is longitudinally offset from the original clutch feed passage 88, the angle of the cutoff passages in both the radial direction (See FIG. 19) and in the longitudinal direction (See FIG. 18) may be substantially offset from the clutch feed passage 88. In addition, as a longitudinal position and longitudinal width of the oil channel 92a is often offset from the oil channel 92, and whereas the oil channel 96 is substantially the same position in both the high range drum 102 and the modified high range drum 102a, the angle of the oil passage 94a in the radial direction (See FIG. 18) may be substantially different than the angle of the oil passage 94 of the unmodified oil transfer hub 84.

Wherein the modified a bearing assembly 70a may be larger in the longitudinal direction 12 than the bearing assembly 70, it may be required to remove (machine) a portion of the surface 142 of the ring gear hub 132 to properly position the larger bearing assembly 70a. In addition, it may be required to remove (machine) a portion of the surface 144 of the high range drum 102, again to properly position the larger bearing assembly 70a.

In some applications it will be preferred not to modify the surface 86 of the casing 68 to allow for a larger outer diameter bearing assembly. In other applications, some modification/machining may be desired to allow for a larger outer diameter bearing assembly. As previously discussed, it may be desired to provide a plug 136, cut off passages 138, and it may also be required to machine or otherwise modify the surface 86 so as to friction fit or slide fit the outer surface 82a of the modified bearing 70a to the surface 86.

In addition, installation of modified bearings 70a as discussed above has shown that use of the bearing keeper 116 without modification after installation of a larger bearing assembly 70a may substantially overlap the bearing assembly 70a in the radial direction and may occlude the flow path 146 through the gap 118. To overcome this, in one example, a significant portion of the radially inward surface 148 of the bearing retainer 116 may be machined (cut) away to enlarge this opening 148. This modification resulting in a larger gap 118a by use of the modified bearing retainer 116a having a larger central opening. In addition, the modified bearing retainer 116a may comprise a longitudinal protrusion 150 to account for a modified (larger) bearing 70a being longer in the longitudinal direction 12 from the original bearing 70. In one form, it may be desired to maintain the longitudinal centerline 152 of the bearing assembly 70a and position relative to the bearing assembly 70.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

1. A transmission lube transfer hub comprising:
a. a longitudinally forward face having a plurality of surfaces defining fastener voids there through and a surface defining a shaft bore there through;
b. a radially outermost convex surface;
c. a cylindrical radially outward convex casing bulkhead engagement surface;
d. a cylindrical radially inward hub engagement surface;
e. a surface defining an circumferential oil channel radially inward of and formed in the casing bulkhead engagement surface;
f. a plurality of oil passages extending from the oil channel to the hub engagement surface;
g. a planar and cylindrical bearing engagement surface; and
h. wherein the lube transfer hub does not extend longitudinally forward of the forward surface of the bearing engagement surface.

2. The transmission lube transfer hub as recited in claim 1 further comprising a circumferential angled chamfer surface extending from the bearing engagement surface to the hub engagement surface.

3. A method for modifying a transmission having a casing with a casing bulkhead with a bore therein; the method comprising the steps of:
a. identifying and removing a first oil transfer hub and an associated first bearing assembly from the casing bulkhead;
b. installing a modified oil transfer hub comprising:
i. a longitudinally forward face having a plurality of surfaces defining fastener voids there through and a surface defining a shaft bore there through;
ii. a radially outermost convex surface;
iii. a cylindrical radially outward convex casing bulkhead engagement surface;
iv. a cylindrical radially inward hub engagement surface;
v. a surface defining an circumferential oil channel radially inward of and formed in the casing bulkhead engagement surface;
vi. a plurality of oil passages extending from the oil channel to the hub engagement surface;
vii. a planar and cylindrical bearing engagement surface;
viii. wherein the lube transfer hub does not extend longitudinally rearward of the forward surface of the bearing engagement surface;
c. replacing the first bearing assembly with a second bearing assembly into the casing bulkhead with a friction fit to the casing bulkhead; and
d. wherein the second bearing assembly has a substantially larger outer diameter than the first bearing assembly and an inner diameter the same as the inner diameter as the first bearing assembly.

4. The method for modifying a transmission as recited in claim 3 further comprising the step of machining a hub of an adjacent ring gear hub to reduce the longitudinally forward edge of the ring gear hub.

5. The method for modifying a transmission as recited in claim 3 further comprising the step of machining a hub of an adjacent high range to reduce the longitudinally forward edge of the ring gear hub.

6. The method for modifying a transmission as recited in claim 3 further comprising the steps of:
a. identifying and plugging a clutch feed passage with a plug adjacent the first bearing assembly; and
b. drilling at least one cutoff passage from the clutch feed passage at a point radially outward of the plug to the circumferential oil channel.

7. The method for modifying a transmission as recited in claim 7 wherein the total cross sectional area of the cutoff passages is equal to or greater than the cross sectional area of the clutch feed passage.

8. The method for modifying a transmission as recited in claim 7 wherein the cutoff passages are at an angle to the clutch feed passage in both a radial and a longitudinal direction.

9. The method for modifying a transmission as recited in claim 3 further comprising the steps of:
a. identifying and removing a first bearing keeper from the casing bulkhead;
b. identifying and machining a substantial portion of a surface defining a central bore hole in the bearing keeper to account for the larger outer diameter of the second bearing assembly.

10. The method for modifying a transmission as recited in claim 3 further comprising the steps of:
a. identifying and removing a first bearing keeper from the casing bulkhead; and
b. replacing the first bearing keeper with a second bearing keeper having a surface defining a central bore hole substantially larger in diameter than the diameter of the surface defining the central bore hole in the first bearing keeper.

11. A transmission lube transfer hub comprising:
a. a longitudinally forward face having a plurality of surfaces defining fastener voids there through and a surface defining a shaft bore there through;
b. a radially outermost convex surface;
c. a cylindrical radially outward convex casing bulkhead engagement surface;
d. a cylindrical radially inward hub engagement surface;
e. a surface defining an circumferential oil channel radially inward of and formed in the casing bulkhead engagement surface;
f. a planar and cylindrical bearing engagement surface; and
g. wherein the lube transfer hub does not extend longitudinally rearward of the forward surface of the bearing engagement surface.
